(19) United States
(12) Patent Application Publication
(10) Pub. No.: US 2024/0265779 A1
(43) Pub. Date: Aug. 8, 2024

(54) SYSTEMS AND METHODS FOR CONTROLLING A GAME AND ADMINISTERING WAGERS ON A GAME

(71) Applicant: Quintopple Limited, Oldbury (GB)

(72) Inventor: Ashley Scott AVERILL, Oldbury (GB)

(21) Appl. No.: 18/165,157

(22) Filed: Feb. 6, 2023

(51) Int. Cl. G07F 17/32

(52) U.S. Cl. CPC G07F 17/3267; G07F 17/3211; G07F 17/3239; G07F 17/3244

(57) ABSTRACT

A computer-implemented method of administering wagers on a game includes: receiving a selection of one or more wagers placed by a player via an interface, each wager denoting a selection of a game outcome; performing the game by: randomly selecting for each piece either its first state or its second state; displaying properties associated with the selected state of each piece; determining a first game outcome by determining the number of game pieces being in a state associated with the first property; and determining a second game outcome by determining the number of game pieces being in a state associated with the second property; and administering credit to a player for each wager for which it is determined that either the first game outcome or the second game outcome corresponds with the game outcome selected for the wager.

### FIELD

The present disclosure relates to systems and methods for controlling a game, and for administering wagers placed on the outcome of a game.

### BACKGROUND

Casino ‘table’ games involving users placing wagers by betting money or tokens (i.e., ‘chips’) on an outcome of the game are well known. Players place wagers on possible outcomes of each game—a certain number or colour being the result of a spin of the roulette wheel, for example.

In this way, the game provides opportunities for a player to place wagers on multiple options relating to various possible outcomes. For example, a player may place multiple wagers on a game, relating to a particular number winning and also a particular colour winning, as an example. These wagers may be mutually exclusive. The player may place a wager on red winning, while at the same time betting on a black number being the specific winning number. In this scenario, either one or the other wager may succeed, but not both.

It is beneficial to increase the engagement of players with games of this type by providing games with multiple outcomes, where players can place wagers on multiple different outcomes each being unrelated to (or at least not strictly dependent on) the other outcomes. In this way, players are encouraged to continue playing the games and to place combinations of wagers on unrelated outcomes within the framework of the game.

It is also advantageous to provide a clear cut-off for players placing wagers, so that in a live hosted setting in which a host plays the game under observation by the players, there is no danger of an overlap occurring wherein a player attempts to place a wager on the outcome of the game when it is already underway.

Further, in a live hosted setting, players need to be provided with a clear visual indication of the game and its result, leaving no doubt about the outcome of wagers placed on the game. It is therefore advantageous to provide technology for determining the outcome of the game quickly and reliably in a way that is observable by players.

### BRIEF DESCRIPTION OF THE DISCLOSURE

In general terms, the disclosure relates to an interactive gambling game on which a player may place wagers via an interface. The game may be provided by a standalone gambling machine (in a casino environment for example), or the game may be hosted at an online server or host station and accessed by one or more players over the internet via remote player interfaces. The game may involve a software-generated representation of the game for display to one or more users via a display screen. In alternative embodiments, the game may involve a live host interacting with physical game components to play rounds of the game, each round being recorded and broadcast to one or more users.

According to a first aspect of the disclosure, we provide a computer-implemented method of administering wagers on a game, the game being of a type on which a player places a wager on one or more game outcomes from a predetermined set of possible game outcomes prior to the game being played, the game including a set of multiple game pieces each having a first state and a second state, the set of game pieces including one or more game pieces of a first type and one or more game pieces of a second type, and each state of each game piece being associated with two different properties, such that:
the first state of the first type of piece is associated with a first property and a second property,
the second state of the first type of piece is associated with a third property and a fourth property,
the first state of the second type of piece is associated with the first property and the fourth property, and
the second state of the second type of piece is associated with the second property and the third property;
wherein the game is played by randomly selecting for each piece either its first state or its second state, and displaying the associated properties of that state to the player,
each game outcome representing a total number of game pieces being in a state that is associated with one of: the first property, the second property, the third property, or the fourth property,
wherein the number of game pieces being in a state associated with either the first or third property is not dependent on the number of game pieces being in a state associated with the second or fourth property;
the method involving the steps of:
receiving a selection of one or more wagers placed by the player via an interface, each wager denoting a selection of a game outcome;
performing the game by:
   determining for each game piece either its first state or its second state;
   displaying at a display device the properties associated with the selected state of each game piece; and
   using the processor, determining a first game outcome by determining the number of game pieces being in a state associated with the first property, and determining a second game outcome by determining the number of game pieces being in a state associated with the second property; and
administering credit to a player for each wager for which it is determined that either the first game outcome or the second game outcome corresponds with the game outcome selected for the wager.

Determining a state of each game piece may include using a processor to randomly select a state.

Randomly selecting for each piece either its first state or its second state may involve making a random selection with 50% likelihood of the first state being selected and 50% likelihood of the second state being selected.

The game may be played with an odd number of game pieces, and preferably five game pieces.

The game may be played with three game pieces of the first type, and two game pieces of the second type.

According to a second aspect of the disclosure, we provide a system for administering wagers on a game, the system including:
a host station having a processor and a storage device coupled to the processor, and
a player interface communicatively coupled to the host station and providing a user interface enabling a player to interact with the host station;
the storage device storing instructions which when executed by the processor, cause the processor to:
   receive a selection via the user interface of the player interface one or more wagers placed by a player, each wager denoting a selection of a game outcome from a predetermined set of possible game outcomes;
   determining for each of multiple game pieces either a first state or a second state;
   cause the display at the display device of one or more properties associated with the selected state of each game piece;
   determine a first game outcome by determining the number of game pieces being in a state associated with a first property, and determine a second game outcome by determining the number of game pieces being in a state associated with a second property; and
   administer credit to the player for each wager for which it is determined that either the first game outcome or the second game outcome corresponds with the game outcome selected for the wager.

The host station and player interface may be provided within a gaming cabinet; i.e., as a single standalone unit for use in a casino for example. Alternatively, the host station may be provided at a server, and the player interface communicatively coupled to the server via the internet.

According to a third aspect of the disclosure, we provide a system for controlling a game, the system including a host station for hosting a live session of the game and configured to communicate with one or more remote player interfaces via which players can place wagers on the game, the host station providing:
a processor;
a storage device coupled to the processor;
a recording device for recording a host playing the game; and
a communication device configured for communicating with one or more remote player interfaces;
the system further including a game piece distribution device configured to distribute multiple game pieces used for playing the game, and
the system being configured such that:
   during a first phase, prior to the game beginning, wagers are placed by players at the remote players stations and communicated to the host station;
   during a second phase, prior to the game beginning, wagers cannot be placed; and
   during a third phase the game is played by distribution of multiple game pieces and during which wagers cannot be placed;
the transition from the first phase to the second phase being triggered by a first stage of operation of the game piece distribution device, and the transition to the third phase from the second phase being triggered by a second stage of operation of the game piece distribution device.

The system may be configured such that the game piece distribution device distributes the game pieces such that each game piece will adopt either a first state or a second state each with a likelihood of around 50%.

The game piece distribution device may provide a user-operable means for triggering operation of the device, the operation involving:
a signal being generated by the game piece distribution device for receipt by the host station, the receipt of the signal triggering transition from the first phase to the second phase, and subsequently, distribution of the game pieces triggering the transition to the third phase as the game is played.

During the second phase, the host station may communicate a message to be displayed to players via the player interface, the message indicating that wagers cannot be placed. The signal may be an audio signal played via a speaker of the game piece distribution device, and the host station may include a microphone configured to receive the audio signal. Alternatively, the signal may be an electronic signal communicated via a wired or wireless connection between the game piece distribution device and the host station.

The recording device may be a camera, and the host station may be operable to record video footage of the host playing the game, and to communicate the video footage to the one or more remote player interfaces.

According to a fourth aspect of the disclosure, we provide a system for controlling a game, the system including a host station for hosting a live session of the game and configured to communicate with one or more remote player interfaces via which players can place wagers on the game, the game involving the distribution of game pieces each having a first side and a second side, such that either first side or second side faces upward following distribution of the game pieces, each game piece having a machine-readable watermark on at least one of the first side or second side, the host station providing:
a processor;
a storage device coupled to the processor;
a camera for recording a host playing the game; and
a communication device configured for communicating with one or more remote player interfaces;
the camera being operable to receive images of the distributed game pieces,
and the processor being operable to determine for each game piece an image received by the camera, whether a watermark is visible in the image, and where a watermark is visible on a game piece, to determine a state of the respective game piece.

The state of the respective game piece may be associated with one or more properties, and it may be the case that a first game outcome involves determining a total number of game pieces being in a state associated with a first property, and a second game outcome by determining the number of game pieces being in a state associated with a second property.

### BRIEF DESCRIPTION OF THE FIGURES

In order that the present disclosure may be more readily understood, preferable embodiments thereof will now be described, by way of example only, with reference to the accompanying drawings, in which:

FIG. 1 is an isometric view of a game piece used in games as described herein;

FIGS. 2A and 2B are representations of first and second types of game pieces as used in games as described herein;

FIGS. 3A and 3B are diagrammatic representations of results of rounds of a game as described herein;

FIG. 4 is an illustration of an aspect of a user interface for placing wagers, in accordance with embodiments of the described technology;

FIG. 5 is a diagrammatic representation of a system according to embodiments of the described technology, in which a host station and user station are provided in a standalone unit;

FIG. 6 is a diagrammatic representation of a system according to embodiments of the described technology, providing a host station and a game piece distribution device, and wherein multiple remote players interact with the host station via remote player interfaces;

FIG. 7 is a diagrammatic representation of a system according to embodiments of the described technology, providing a host station that is coupled to multiple remote player interfaces;

FIG. 8 provides an isometric view of a alternative game piece in accordance with some embodiments of the described technology, the game piece providing a machine-readable watermark;

FIG. 9 is a representation of multiple game pieces of the type illustrated in FIG. 8, and a camera recording images of the game pieces as the game is played;

FIG. 10 provides an isometric representation of a game piece distribution device according to embodiments of the described technology, shown in combination with a microphone;

FIG. 11 provides a diagrammatic representation of a player interface for use with systems according to embodiments of the described technology; and

FIG. 12 is a flow chart illustration of method steps according to embodiments of the described technology.

### DETAILED DESCRIPTION OF THE DISCLOSURE

It should be understood that the following description of the game and system for controlling the game, and method of administering wagers placed on the game, are by way of example only and are not intended to be limiting on the claimed scope of the disclosure.

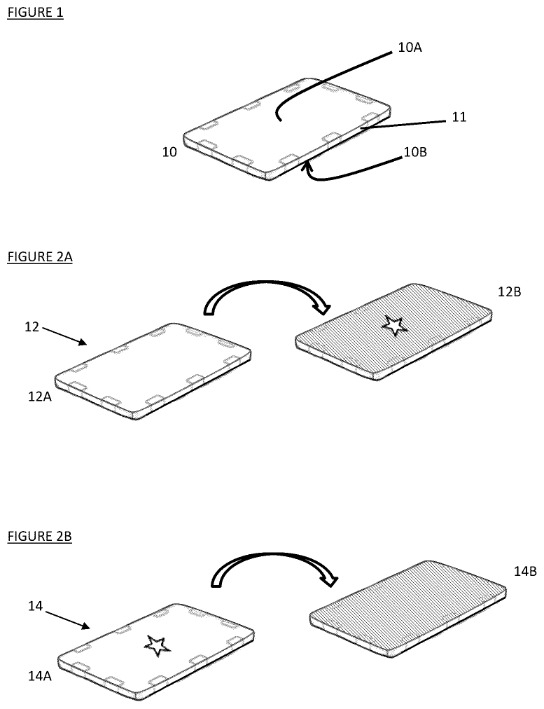

We first describe the game with reference to FIGS. 1, 2A, 2B, 3A and 3B. The game is played on a generally flat playing surface, onto which surface multiple game pieces 10 are thrown or dropped. A game piece 10 is illustrated in FIG. 1, the game piece 10 being a generally flat object having a first side 10A and a second side 10B. In the example shown, the game piece 10 is substantially rectangular, and has corners that are slightly rounded. It should be understood that game pieces of other shapes are also suitable (i.e., round, triangular, elongate, square, or any other shape). The only requirement of the game piece 10 shape is that the piece is ‘fair’ in that the two sides of the piece are substantially identical, and have an even weight distribution, so that when the piece is thrown or dropped ‘randomly’ on to the playing surface, there is a probability of approximately ½ (50%) that it will land on either one of its two sides.

An edge 11 of the game piece 10 is sufficiently thin to make the likelihood of the game piece 10 being balanced stably on its edge 11 very low. In embodiments of the described technology, the edge 11 of the game piece 10 is curved, so that the game piece 10 cannot be balanced when standing on its edge 10. In practice, what matters is that the game piece 10 is designed such that throwing or dropping the game piece 10 onto a flat playing surface results in the game piece 10 coming to rest in a position in which one side lies face down and the other lies face up. The side facing upwards is said to be the active state of the game piece 10.

When the game is simulated in a virtual environment, each game piece 10 is activated during each game so that an active state of the game piece 10 is selected at random from its first side 10A and its second side 10B using a random number generator as is known in the art.

The game involves two types of game piece 10, the first type 12 illustrated in FIG. 2A, and the second type 14 illustrated in FIG. 2B. The two sides of the respective game pieces 12, 14 are referred to herein as a first state and a second state, respectively, so that during each game each game piece 12, 14 is determined to be in either its first state or its second state, representing the game piece 12, 14 having settled on its first side or its second side, respectively.

Each state of each game piece is associated with two different properties. In the described embodiments of the technology, one property is a color, and the other represents the presence or absence of a star symbol on the respective side of the game piece 10, 12, 14.

As shown, each game piece 10, 12, 14 is colored red on one of its sides, and colored black on its other side. Of course, the choice of red and black colors is arbitrary, and any combination of colors may be used—preferably the colors being easily distinguishable from each other. In the example described, the first property is the color red (shown in the drawings as plain white), and the second property is the absence of a star symbol. It should also be understood that the choice of a star symbol, and the alternative lack of a star symbol, as properties is an arbitrary choice. Any visual depiction may be used, to differentiate between two options—for example, a star and a cross symbol, or a striped pattern and a circle, or another other combination of distinguishable symbols, patterns, or other forms of depiction may be used.

Looking at FIG. 2A, the first type of game piece 12 is illustrated, its first state 12A (i.e., first side) having properties one and two, as it is red and has no star symbol on its face. Turning the game piece 12 over to its second state 12B (i.e., second side) we see that it has properties three and four, as it is black and has a star displayed on its face. In this sense properties one and three are complementary, as each face of each game piece 10, 12, 14 is either colored red or black. In the same sense, properties two and four are also complementary, as each face of each game piece 10, 12, 14 either has a star symbol illustrated on its face, or no star symbol illustrated on its face.

Looking at FIG. 2B we see the second type of game piece 14 illustrated, having a first state 14A associated with properties one and four (i.e., red with a star symbol), and a second state 14B associated with properties two and three (i.e., black with no star symbol).

The game is typically played using multiple game pieces of each type—one or more game pieces of the first type 12, and one or more game pieces of the second type 14. Preferably, and in the embodiment illustrated and describe, the game is played with an odd number of game pieces 10, 12, 14. In the embodiment of the game described, the game is played using five game pieces 10, 12, 14, three of the first type 12 and two of the second type 14.

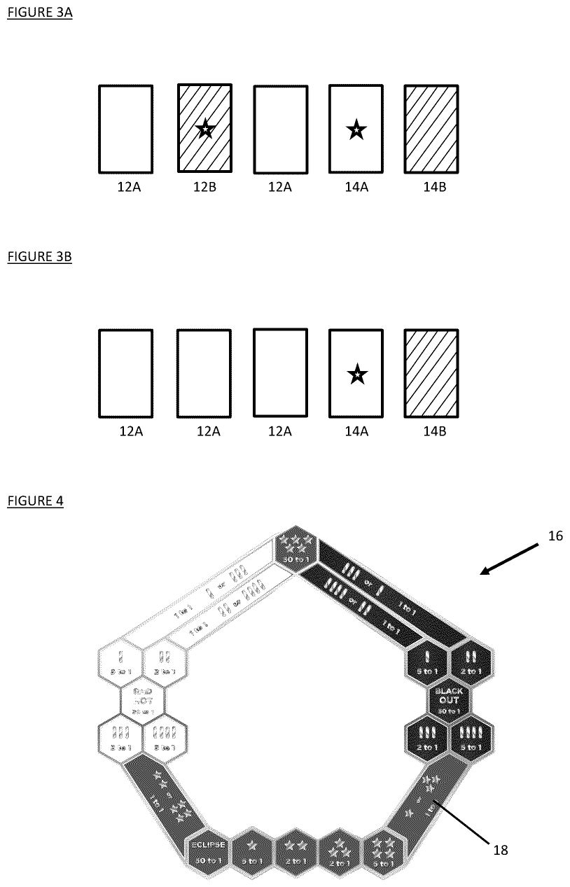

FIGS. 3A and 3B illustrate the outcome of two example games. In each game, the host overseeing the game collects together the five game pieces 10, 12, 14 and drops them or throws them in a way that is as random as possible, so that each game piece 10, 12, 14 has an approximately 50% likelihood of landing and settling in its first state or in its second state. In FIG. 3A we see that two of the first type of game piece 12 have settled in their first state 12A, and one has settled in its second state 12B. One of the second type of game pieces 14 has settled in its first state 14A, and the other has settled in its second state 14B.

To determine the outcome of the game, the number of game pieces 10, 12, 14 that have settled in a state associated with each of the four properties is counted. For property one (i.e., red), we see that three of the game pieces have settled in a state associated with that property—the first, third and fourth of the row of five game pieces illustrated. It follows that the remaining two game pieces have settled in a state associated with property three (i.e., black), and we can see that is the case—the second and fifth game pieces in the row. Similarly, we find that three of the game pieces have settled in a state associated with property two (i.e., without a star symbol); the first, third and fifth game pieces shown in the row. It follows that the remaining two game pieces have settled in a state associated with property four (i.e., with a star symbol); the second and fourth game pieces in the row.

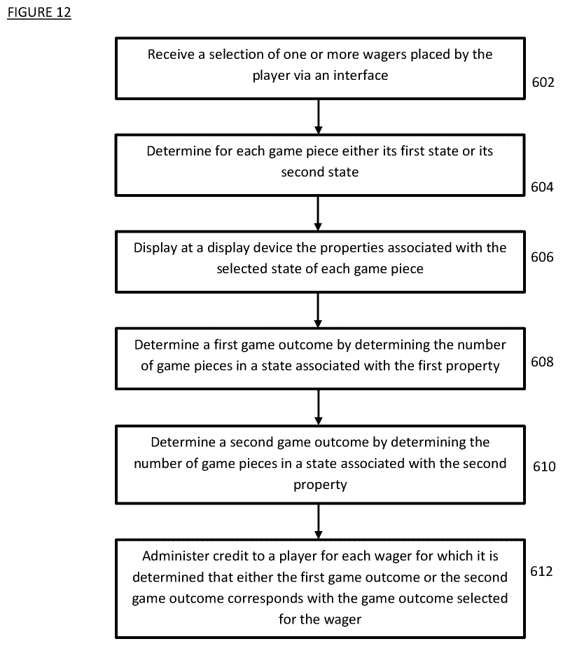

In broad terms, a computer-implemented method of administering wagers on the game is described, with reference to FIG. 12. Prior to the game being played, each player places a wager on one or more game outcomes from a predetermined set of possible game outcomes. Each game outcome represents a total number of game pieces being in a state that is associated with one of: the first property, the second property, the third property, or the fourth property. In other words, each player can place a wager on the number of game pieces 10, 12, 14 that will settle with a red side uppermost, or without star symbol showing, or with a black side uppermost, or with a star symbol showing. For each of those properties there are six possible outcomes of the game, either zero pieces, one piece, two pieces, three pieces, four pieces or five pieces.

The thirty-two permutations of first outcomes of each game are listed in Table 1 below, the first outcomes being associated with properties one and three (i.e., red and black colors).

TABLE 1
The permutations of possible outcomes for Red/Black properties.

| | 5 Red | 4 Red | 3 Red | 3 Black | 4 Black | 5 Black |
|---|---|---|---|---|---|---|
| 1 | RRRRR | | | | | |
| 2 | | RRRRB | | | | |
| 3 | | RRRBR | | | | |
| 4 | | RRBRR | | | | |
| 5 | | RBRRR | | | | |
| 6 | | BRRRR | | | | |
| 7 | | | RRRBB | | | |
| 8 | | | RRBRB | | | |
| 9 | | | RRBBR | | | |
| 10 | | | RBRRB | | | |
| 11 | | | RBRBR | | | |
| 12 | | | RBBRR | | | |
| 13 | | | BRRRB | | | |
| 14 | | | BRRBR | | | |
| 15 | | | BRBRR | | | |
| 16 | | | BBRRR | | | |
| 17 | | | | RRBBB | | |
| 18 | | | | RBRBB | | |
| 19 | | | | RBBRB | | |
| 20 | | | | RBBBR | | |
| 21 | | | | BRRBB | | |
| 22 | | | | BRBRB | | |
| 23 | | | | BRBBR | | |
| 24 | | | | BBRRB | | |
| 25 | | | | BBRBR | | |
| 26 | | | | BBBRR | | |
| 27 | | | | | RBBBB | |
| 28 | | | | | BRBBB | |
| 29 | | | | | BBRBB | |
| 30 | | | | | BBBRB | |
| 31 | | | | | BBBBR | |
| 32 | | | | | | BBBBB |
| | 1 | 5 | 10 | 10 | 5 | 1 |

While Table 1 addresses the permutations for properties one and three, the same permutations also apply to properties two and four, by substituting Red and Black for ‘Star’ and ‘No star’.

If the player places a wager on the correct number of pieces in a state associated with that chosen property, the player wins the wager and is credited for the win. The likelihoods associated with the different numbers of pieces being associated with any property varies, and so the amount won by the player differs accordingly. For example, the probability of three of the game pieces 10, 12, 14 settling with red showing uppermost is 10/32 (ten of the 32 permutations of possible outcomes for the five game pieces), whereas the probably of a single one of the game pieces 10, 12, 14 settling with red showing uppermost is 5/32. The wager pays an amount that scales inversely with the probability of the outcome, as is typical with casino table games.

Table 2, below, sets out the odds or likelihood of each outcome occurring (e.g. odds of 32 indicate a 1 in 32 likelihood of that outcome occurring in a game), and includes the combined odds of multiple outcomes such as “either 1 or 3 red”—a feature discussed further, below.

TABLE 2
The likelihood of each outcome.

| Selection | Type | Odds |
|---|---|---|
| 5 Red | Single | 32.00 |
| 4 Red | Single | 6.40 |
| 3 Red | Single | 3.20 |
| 2 Red | Single | 3.20 |
| 1 Red | Single | 6.40 |
| 5 Black | Single | 32.00 |
| 4 Black | Single | 6.40 |
| 3 Black | Single | 3.20 |
| 2 Black | Single | 3.20 |
| 1 Black | Single | 6.40 |
| 2 or 4 black/red | Multiple | 2.13 |
| 1 or 3 black/red | Multiple | 2.13 |
| 5 Stars | Single | 32.00 |
| 4 Stars | Single | 6.40 |
| 3 Stars | Single | 3.20 |
| 2 Stars | Single | 3.20 |
| 1 Star | Single | 6.40 |
| 0 Stars | Single | 32.00 |
| 2 or 4 stars | Multiple | 2.13 |
| 1 or 3 stars | Multiple | 2.13 |

It should be noted that the number of game pieces 10, 12, 14 being in a state associated with either the first or third property is not dependent on the number of game pieces being in a state associated with the second or fourth property. In other words, there is no direct association between the number of game pieces 10, 12, 14 that settle on red, compared to the number that settle with a star symbol visible. If three game pieces settle on red, this does not result in there being two star symbols visible, for example; it is possible for other numbers of star symbols to be visible. This means that the player has the opportunity to place wagers on two different outcomes associated with each game. The first outcome relates to the number of game pieces in states associated with the first and/or third properties (i.e., red or black), and the second outcome relates to the number of game pieces in states associated with the second and/or fourth properties (i.e., star or no star).

This ability to engage with two different outcomes and to place wagers on those different outcomes that are not mutually exclusive, assists in achieving higher player engagement with the game, and to encourage multiple wagers to be placed by a player prior to the start of each game.

FIG. 4 illustrates an example betting interface 16 forming a portion of a user interface of a system controlling the game. The betting interface provides multiple spaces 18 each associated with a particular outcome of the game, or associated with a combination of outcomes of the game. For example, the betting interface provides a space associated with the number of game pieces associated with property one (i.e., colored red) being 0, 1, 2, 3, 4 or 5. Placing a wager on one of those outcomes will result in a win if that specific number occurs. While placing a wager on property one=3 pieces is equivalent to placing a wager on property three=2 pieces (i.e., if one occurs, the other must also occur), for the aesthetic appearance of the betting interface it may be advantageous to include spaces for placing wagers on each option, i.e., on the outcomes associated with property 1 and the outcomes associated with property three.

One or more spaces within the betting interface may be associated with two or more possible outcomes of the game. For example, a space may be associated with the outcome for property one being either 1 or 3, or a space may be associated with the outcome for property four being either 2 or 4. In those cases, the wager will be deemed to be successful if either one of those two outcomes occurs when the game is played.

With reference to FIGS. 5, 6 and 7, the system running the game provides a host station 100, 200, 300 having a processor 102, 202, 302 and a storage device 104, 204, 304 coupled to the processor 102, 202, 302. A player interface 116, 210, 310 is communicatively coupled to the host station 100, 200, 300 and provides a user interface 108, 208, 308 enabling a player to interact with the host station 100, 200, 300. The storage device 104, 204, 304 stores instructions which when executed by the processor 102, 202, 302, cause the processor 102, 202, 302 to receive a selection via the user interface 108, 208, 308 data representing one or more wagers placed by a player (see step 602 of FIG. 12). As mentioned above, each wager denotes a selection of a game outcome from the predetermined set of possible game outcomes.

The game is then performed by distributing the game pieces by randomly selecting (i.e., determining) either a first state or a second state for that game piece (step 604). As described above, in preferred embodiments, five game pieces are used, including three game pieces of the first type 12, and two game pieces of the second type 14. Each of those is assigned either its first state 12A, 14A or its second state 12B, 14B. Randomly selecting for each game piece 12, 14 either its first state 12A, 14A or its second state 12B, 14B involves making a random selection with 50% likelihood of the first state 12A, 14A being selected and 50% likelihood of the second state 12B, 14B being selected.

Optionally, in embodiments of the described technology, prior to each game taking place, a determination is made of the game pieces 10, 12, 14 to use in the forthcoming game. For example, for each game piece being used, a determination is made as to whether that piece is of the first type 12 or the second type 14. Each selection may be made at random, with a 50% likelihood of either outcome.

The processor 102, 202, 302 causes the display (at a display device 112) of one or more properties associated with the selected state of each game piece (step 606). In terms of the preferred game embodiments outlined above, this involves displaying the game pieces 12, 14 as either red or black (properties one and three), and either with or without a star symbol (properties two and four).

The system subsequently determines a first game outcome (step 608) by determining the number of game pieces being in a state associated with the first property (i.e., red), and determining a second game outcome (step 610) by determining the number of game pieces being in a state associated with a second property (i.e., with a star symbol). Further determination may be made of the number of game pieces being in a state associated with the third property (i.e., black), or the fourth property, for example, but that can easily be calculated using the above determination of the number for the first property.

The system subsequently administers credit to the player for each winning wager (step 612). A winning wager is determined as one that matches either the first game outcome or the second game outcome (or a further game outcome such as the number associated with the third or fourth property as mentioned above). Administering credit involves incrementing a recording credit sum associated with a player's account (and storing that incremented value on the storage device).

In the embodiment of the system shown in FIG. 5, the system is provided as a standalone gaming cabinet, such as those found alongside slot machines in a casino. In this way, the gaming cabinet provides a host station 100 connected to a player interface 116. The player interface provides a display device 112 for displaying the game, a betting interface 113, and a user interface 108 for allowing a player to interact with the game by placing wagers for example. In embodiments of the technology the user interface 108 is combined with the display device 112 via a touchscreen control, for example. In other embodiments the user interface 108 is provided by one or more peripheral hardware components such as one or more buttons, and one or more joysticks or other forms of cursor control devices.

The host station 100 provides a processor 102, storage device 104 and memory device 106. In embodiments of the technology, the host station 100 provides or is associated with a mechanism for receiving and/or processing payment 114, such as known coin slot systems or card-reader technologies. In embodiments, the host station 100 is connected to a local area network and/or is connected to a server 110 via the internet, and the player may access a player account, the player account holding detail of credit associated with the player. In an embodiment providing a standalone gaming cabinet, administering credit to the player may involve dispensing coins or credit vouchers, or providing a payment to a credit account, via the mechanism for processing payment 114.

In other embodiments, the host station 200 is provided at a server, and the player interface 208 is provided at a remote player interface 210. The player interface 210 is communicatively coupled to the host station 200 and its server via the internet, or may be connected via a local area network. The host station 200 provides a processor 202, a storage device 204 coupled to the processor, and a recording device 212 for recording a host playing the game. In this setting, a live host plays the game using physical game pieces 10, 12, 14 on a playing surface, and the footage of the game being played is streamed either live, or with a time delay, or as a video recording, to players viewing the game remotely via the player interfaces 210. The host station 200 provides a communication device 216 configured for communicating with the one or more remote player interfaces 210, so as to send data representative of the video stream, and/or to receive data indicative of wagers placed by the player(s).

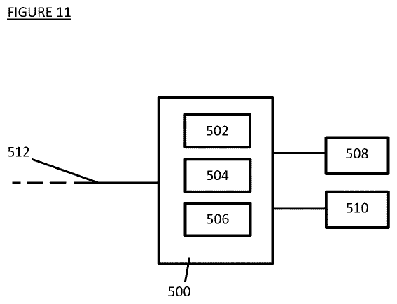

To aid the host in playing the game in a manner in which the game pieces are seen to be distributed fairly, and randomly, the system further includes a game piece distribution device 406 (see FIG. 10), for example. The game piece distribution device 406 is configured to distribute multiple game pieces 10, 12, 14 used for playing the game. In embodiments of the described technology, the game piece distribution device 406 provides a number of slots 408 equal to the number of game pieces being used to play the game—in the preferred embodiment described, five slots 408. The device 406 is adapted to receive a game piece 10 into each of its slots, and to distribute the game pieces 10 onto a gaming surface in a manner that renders the likelihood of each game piece 10 settling on either its first side or its second side as approximately 50%. To achieve this, the device 406 is configured to launch each game piece 10 by way for a lever or the like, to land on its edge 11, so that subtle collisions between the pieces and slight variants in impact angle lead to a substantially randomized motion as the game pieces 10 are all distributed.

In embodiments of the technology, the device 406 provides a user-operable means 410 such as a button, lever, or the like, to cause distribution of the game pieces 10 from the device 406. Preferably, there is a delay between operation of the user-operable means 410 and the distribution of the game pieces 10.

When streaming the live footage to remote player interfaces 210, it is advantageous to provide a delay between operating the device 406 and the game commencing. This is so that wagers cannot be placed on the game once the device 406 is operated, to avoid players placing wagers on the outcome at a time in which the game pieces 10 are in motion. A clear cut-off point must be provided, after which no wager may be placed, and prior to the game commencing. To enable this, a signal may be generated by the game piece distribution device 406 for receipt by the host station 200. The receipt of the signal triggers a transition from a first phase prior to the game commencing, during which players are able to place wagers via the remote player interfaces 210, to a second phase during which wagers cannot be placed. On receipt of the signal by the host station 200, a signal is transmitted to each remote player interface 210, causing the respective player interfaces 210 to disable the ability for wagers to be placed. During this phase, a message may be displayed to players via the player interface 210, the message indicating that wagers cannot be placed. After a pause, the game piece distribution device 406 subsequently distributes the game pieces 10 thereby triggering the transition to a third phase as the game is played.

In embodiments of the technology, the host station 200 provides a microphone 214 for recording audio signals. In this way, the live host may talk to and engage with the remote players as the game is played, the audio signal being relayed to the player interfaces via the communication device 216.

In embodiments of the technology, the signal generated by the game piece distribution device 406 is an audio signal played via a speaker 412 of the game piece distribution device 406, and the host station 200 includes 214 a microphone configured to receive the audio signal. In other embodiments, the game piece distribution device 406 is connected to the host station 200 via a wired or wireless connection, and the signal is an electronic signal communicated via the wired or wireless connection between the game piece distribution device 406 and the host station 200.

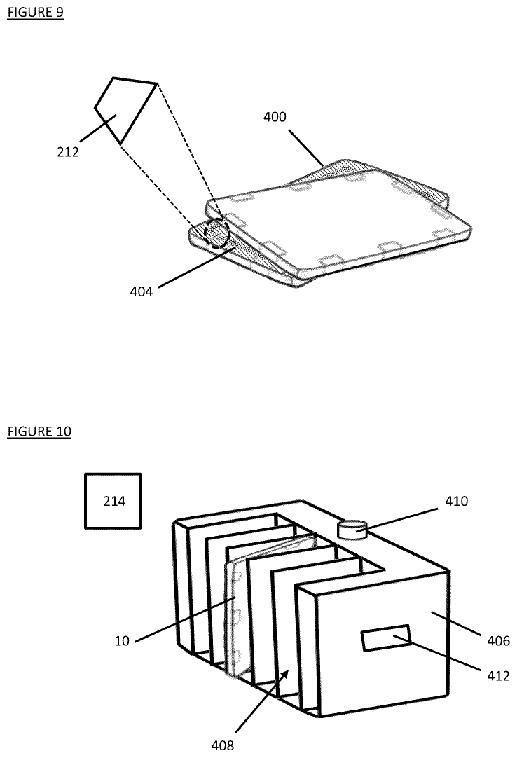

In embodiments of the technology involving a live host, where physical game pieces 10, 12, 14 are distributed to play the game, it is possible that the game pieces will settle in a position in which one or more game pieces 10, 12, 14 are overlapped by other game pieces 10, 12, 14. Such a scenario is illustrated in FIG. 9.

Where physical game pieces 10, 12, 14 are being used, it is advantageous to provide monitoring via the camera 212, to automatically establish the state of each game piece 12, 14 as it settles. In this way, the outcome of each game may be relayed accurately and quickly to the remote players. For example, the camera 212 or the host station 200 may provide automatic detection of the colour of each game piece 12, 14 from the image feed captured by the camera, and may also detect the presence of a star symbol or otherwise on each game piece 12, 14.

With reference to FIGS. 8 and 9, in some embodiments of the technology, each game piece 400 is provided with a machine-readable image (i.e., a watermark 404) at positions at or adjacent to the edge of the piece 400, on one or both sides of the piece 400. The watermark 404 is preferably provided around substantially the entire perimeter of the game piece 400 on both sides.

During the game, the processor 202 is operable to determine for each game piece 400 an image received by the camera 212 whether a watermark 404 is visible on the game piece 400, and where the watermark 404 is visible, to determine a state of the respective game piece 400. By determining the state of the game piece 400, we mean that a determination is made as to the type of the game piece 400 and whether the game piece is in its first or second state, and consequently, the properties that are associated with the game piece 400 in that state. For example, reading the watermark may determine that the game piece is of the second type 14, and is in its second state 14B, such that it has associated properties three and two—black, and with no star symbol present. On that basis, a quick determination can be made at the host station 200, by the processor 202, about the outcome of the game even though the majority of the face of the game piece 14B cannot be viewed by the camera 212.

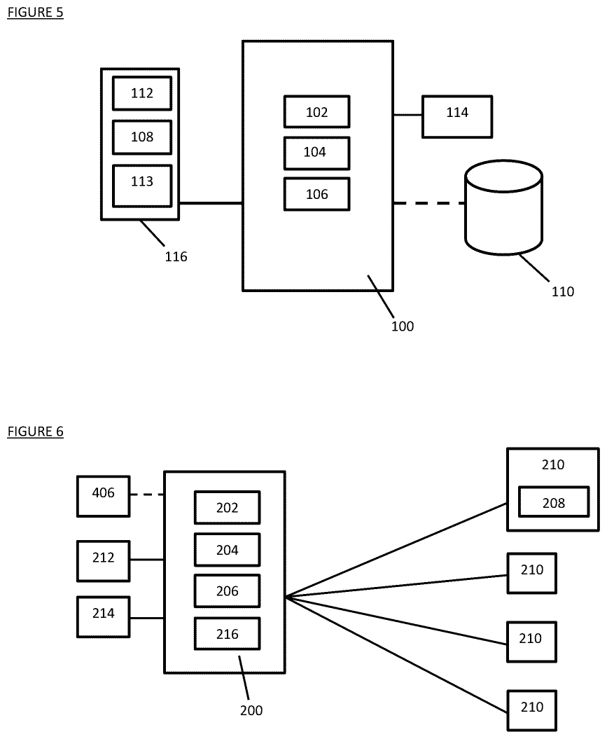

We have described above a first embodiment of the system in which a gaming cabinet provides both a host station 100 and player interface 116 and the game is performed electronically (i.e., as shown in FIG. 5). We have described another embodiment in which the game is hosted on a central host station 200 running on a server, and players connect to and interact with the game via remote player interfaces 210, and in which the game is played by a live host using physical game pieces 10, 12, 14 (with reference to FIG. 6).

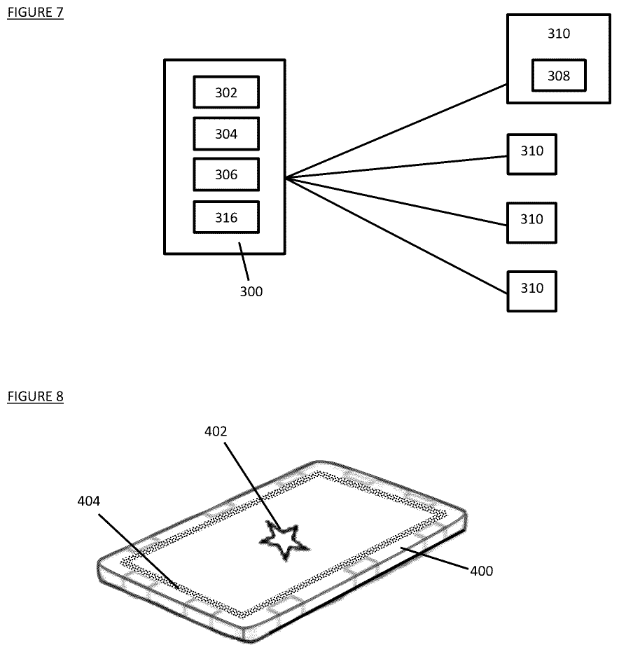

With reference now to FIG. 7, in a further embodiment now described, we provide a central host station 300 running on a server, in which the game is performed electronically via the processor 302 of the host station 300, and players interact with the game via remote player interfaces 310. The host station 300 is provided at a server, and the user interface 308 is provided at the remote player interface 310. The player interface 310 is communicatively coupled to the host station 300 and its server via the internet, or may be connected via a local area network.

The host station 300 provides a processor 302, and a storage device 304 coupled to the processor 302, and a memory device 306. The host station 300 provides a communication device 316 configured for communicating with the one or more remote player interfaces 310, to send data representative of the game being played and the outcome of each game, and/or to receive data indicative of wagers placed by the players.

Finally, with reference to FIG. 11 we describe a remote player interface 500 suitable for use with the above-described embodiments of the technology. The player interface 500 is connected via a local area network or internet connection 512 to a host station 200, 300. The player interface 500 is typically run on a general purpose computer such as a laptop, PC or workstation, or may be provided on a smart device such as a mobile smart phone or tablet, for example, the computer providing a processor 502, storage device 504 and memory device 506. In embodiments, the player interface 500 is connectable to or provides a visual display 508 for displaying content to a player (such content including streamed video footage of the game being played, a graphical representation of the outcome of a game that has been played, and/or a betting interface, for example). The player interface 500 further provides a means of user input 510 such as a keyboard, mouse, joystick, touchscreen, or any other suitable input device as is known in the art.

When used in this specification and claims, the terms “comprises” and “comprising” and variations thereof mean that the specified features, steps or integers are included. The terms are not to be interpreted to exclude the presence of other features, steps or components.

The disclosure may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the disclosure have been described, the scope of the appended claims is not intended to be limited solely to these embodiments. The claims are to be construed literally, purposively, and/or to encompass equivalents.

1. A computer-implemented method of administering wagers on a game, the game being of a type on which a player places a wager on one or more game outcomes from a predetermined set of possible game outcomes prior to the game being played, the game including a set of multiple game pieces each having a first state and a second state, the set of game pieces including one or more game pieces of a first type and one or more game pieces of a second type, and each state of each game piece being associated with two different properties, such that:
the first state of the first type of piece is associated with a first property and a second property,
the second state of the first type of piece is associated with a third property and a fourth property,
the first state of the second type of piece is associated with the first property and the fourth property, and
the second state of the second type of piece is associated with the second property and the third property;
wherein the game is played by randomly selecting for each piece either its first state or its second state, and displaying associated properties of that state to the player,
each game outcome representing a total number of game pieces being in a state that is associated with one of: the first property, the second property, the third property, or the fourth property,
wherein a number of game pieces being in a state associated with either the first or third property is not dependent on a number of game pieces being in a state associated with the second or fourth property;
the computer-implemented method comprising:
receiving a selection of one or more wagers placed by the player via an interface, each wager denoting a selection of a game outcome;
performing the game by:
determining for each game piece either its first state or its second state;
displaying at a display device properties associated with the selected state of each game piece; and
using a processor, determining a first game outcome by determining a number of game pieces being in a state associated with the first property, and determining a second game outcome by determining a number of game pieces being in a state associated with the second property; and
administering credit to the player for each wager for which it is determined that either the first game outcome or the second game outcome corresponds with the game outcome selected for the wager.

2. The computer-implemented method according to claim 1, wherein determining for each game piece either its first state or its second state involves randomly selecting one of the first state or second state.

3. The computer-implemented method according to claim 1, wherein determining for each game piece either its first state or its second state involves making a random selection with 50% likelihood of the first state being selected and 50% likelihood of the second state being selected.

4. The computer-implemented method according to claim 1, wherein the game is played with an odd number of game pieces.

5. The computer-implemented method according to claim 1, wherein the game is played with three game pieces of the first type, and two game pieces of the second type.

6. A system for administering wagers on a game, the system including:
a host station having a processor and a storage device coupled to the processor, and
a player interface communicatively coupled to the host station and providing a user interface enabling a player to interact with the host station;
the storage device storing instructions which when executed by the processor, cause the processor to:
receive a selection via the user interface of the player interface of one or more wagers placed by the player, each wager denoting a selection of a game outcome from a predetermined set of possible game outcomes;
determine for each of multiple game pieces either a first state or a second state;
cause a display at a display device of one or more properties associated with the selected state of each game piece;
determine a first game outcome by determining a number of game pieces being in a state associated with a first property, and determine a second game outcome by determining a number of game pieces being in a state associated with a second property; and
administer credit to the player for each wager for which it is determined that either the first game outcome or the second game outcome corresponds with the game outcome selected for the wager.

7. The system according to claim 6, wherein the host station and player interface are provided within a gaming cabinet.

8. The system according to claim 6, wherein the host station is provided at a server, and the player interface is communicatively coupled to the server via the internet.

9. A system for controlling a game, the system including a host station for hosting a live session of the game and configured to communicate with one or more remote player interfaces via which players can place wagers on the game, the host station providing:
a processor;
a storage device coupled to the processor;
a recording device for recording a host playing the game; and
a communication device configured for communicating with one or more remote player interfaces;
the system further including a game piece distribution device configured to distribute multiple game pieces used for playing the game, and
the system being configured such that:
during a first phase, prior to the game beginning, wagers are placed by players at the remote players stations and communicated to the host station;
during a second phase, prior to the game beginning, wagers cannot be placed; and
during a third phase the game is played by distribution of multiple game pieces and during which wagers cannot be placed;
a transition from the first phase to the second phase being triggered by a first stage of operation of the game piece distribution device, and a transition to the third phase from the second phase being triggered by a second stage of operation of the game piece distribution device.

10. The system of claim 9 configured such that the game piece distribution device distributes the game pieces such that each game piece will adopt either a first state or a second state each with a likelihood of around 50%.

11. The system of claim 9 wherein the game piece distribution device provides a user-operable means for triggering operation of the device, the operation involving:
a signal being generated by the game piece distribution device for receipt by the host station, the receipt of the signal triggering transition from the first phase to the second phase, and
subsequently, distribution of the game pieces triggering the transition to the third phase as the game is played.

12. The system of claim 11, wherein during the second phase, the host station communicates a message to be displayed to players via the player interface, the message indicating that wagers cannot be placed.

13. The system of claim 11, wherein the signal is an audio signal played via a speaker of the game piece distribution device, and the host station including a microphone configured to receive the audio signal.

14. The system of claim 11, wherein the signal is an electronic signal communicated via a wired or wireless connection between the game piece distribution device and the host station.

15. The system of claim 9, wherein the recording device is a camera, and the host station is operable to record video footage of the host playing the game, and to communicate the video footage to the one or more remote player interfaces.

16. A system for controlling a game, the system including a host station for hosting a live session of the game and configured to communicate with one or more remote player interfaces via which players can place wagers on the game, the game involving a distribution of game pieces each having a first side and a second side, such that either first side or second side faces upward following distribution of the game pieces, each game piece having a machine-readable watermark on at least one of the first side or second side, the host station providing:
a processor;
a storage device coupled to the processor;
a camera for recording a host playing the game; and
a communication device configured for communicating with one or more remote player interfaces;
the camera being operable to receive images of the distributed game pieces,
and the processor being operable to determine for each game piece an image received by the camera, whether a watermark is visible in the image, and where a watermark is visible on a game piece, to determine a state of a respective game piece.

17. The system of claim 16, wherein the state of the respective game piece is associated with one or more properties, and wherein a first game outcome involves determining a total number of game pieces being in a state associated with a first property, and a second game outcome by determining a number of game pieces being in a state associated with a second property.
